(19) United States
(12) Patent Application Publication
(10) Pub. No.: US 2012/0144049 A1
(43) Pub. Date: Jun. 7, 2012

(54) POLICY AND/OR CHARGING CONTROL FOR A COMMUNICATION SESSION

(76) Inventors: Ana Maria Lopez Nieto, Madrid (ES); Avelina Pardo-Blazquez, Madrid (ES)

(21) Appl. No.: 13/390,608

(22) PCT Filed: Sep. 4, 2009
(86) PCT No.: PCT/EP2009/061465

§ 371 Date: Feb. 15, 2012

(51) Int. Cl. G06F 15/16

(52) U.S. Cl. 709/228

(57) ABSTRACT

According to a first aspect of the present invention there is provided a method of implementing policy and/or charging control for user communication sessions over an IP Connectivity Access Network. The method comprises: at a Policy and Charging Enforcement Function, configuring a plurality of profiles, each profile defining one or more policy and/or charging control characteristics; at a Policy and Charging Rules Function, configuring a plurality of profile selection rules to be used to determine which of the plurality of profiles should be applied to communication sessions; at the Policy and Charging Enforcement Function, when establishing a communication session, sending a request for policy and/or charging control characteristics for the session to the Policy and Charging Rules Function; at the Policy and Charging Rules Function, receiving the request, using the profile selection rules to select one or more profiles, and sending a response to the Policy and Charging Enforcement Function including an identifier for each of the one or more selected profiles; and at the Policy and Charging Enforcement Function, receiving the response, retrieving the one or more policy and/or charging control characteristics from the one or more selected profiles identified in the response and enforcing the retrieved characteristics for the session.

### TECHNICAL FIELD

The present invention relates to control of a communication session. More particularly, the invention relates to implementing policy and/or charging control for a communication session over an IP Connectivity Access Network.

### BACKGROUND

Telecommunications services provided over an IP Connectivity Access Network (IP-CAN) can be subject to charging and policy control mechanisms. This includes Quality of Service (QoS) control. Accordingly, some telecommunications systems incorporate Policy and Charging Control (PCC) architectures to provide this control. 3GPP TS 23.203 V8.1.1 describes such a PCC architecture in respect of packet flows in an IP-CAN session established by a user terminal through an Evolved 3GPP telecommunications system, including both 3GPP accesses (GERAN/UTRAN/E-UTRAN) and Non-3GPP accesses. FIG. 1 illustrates schematically an example of the PCC architecture described in 3GPP TS 23.203 that comprises a Policy and Charging Enforcement Function (PCEF), a Bearer Binding and Event Reporting Function (BBERF), a Policy and Charging Rules Function (PCRF), an Application Function (AF), an Online Charging System (OCS), an Offline Charging System (OFCS) and the Subscription Profile Repository (SPR).

The PCRF is a functional element that encompasses policy control decision and flow based charging control functionalities, a combination of the functionality of the Policy Decision Function (PDF) and the Charging Rule Function (CRF) defined in release 6 of the 3GPP specification. A PCRF can be implemented as a standalone node and behaves as a Policy Decision Point (PDP), or Policy Server (PS), that stores user data related to QoS enforcement, access control lists, etc. The PCRF provides policy and charging control for the media components negotiated between the user terminal and the AF. The PCRF receives session and media related information from the AF and informs the AF of traffic plane events. The PCRF also provides network control regarding service data flow detection, gating, QoS and flow based charging (except credit management) towards the PCEF. The PCRF can provision PCC rules and PCC decisions to the PCEF via the Gx reference point. Criteria such as the QoS subscription information may be used together with policy rules such as, service-based, subscription-based, or pre-defined PCRF internal policies to derive the authorized QoS to be enforced for a service data flow. The PCRF PCC decisions may be based on one or more of the following:
information obtained from the AF via the Rx reference point, e.g. the session, media and subscriber related information;
information obtained from the PCEF via the Gx reference point, e.g. IP-CAN bearer attributes, request type, subscriber related information and location information;
information obtained from the SPR via the Sp reference point, e.g. subscriber and service related data;
information pre-defined in the PCRF; and
information obtained from BBERF via the so-called Gxx reference point.

The PCEF is a functional entity that behaves as a Policy Enforcing Point (PEP) for enforcing decisions instructed by the PCRF and the OCS. The PCEF provides service data flow detection (based on the service data flow filter filters defined in the PCC rules) to capture and analyse any user and signalling traffic, to identify the user and to capture details of the service(s) being used. The PCEF can then communicate this information to the PCRF over the Gx interface, to the OCS over the Gy interface and to the OFCS over the Gz interface. The PCEF enforces QoS control according to the QoS authorised by the PCRF. The PCEF is preferably co-located within the gateway node implementing the IP access to the PDN. As such, in a GPRS core network the PCEF is located within the GPRS Gateway Support Node (GGSN), whilst in the case of a CDMA2000 network the PCEF may be located in a Packet Data Serving Node (PDSN), and in a WLAN network the PCEF may be located in a Packet Data Gateway (PDG).

The BBERF functionality includes bearer binding, uplink bearer binding verification and event reporting to the PCRF. For example, in a GPRS core network the bearer binding mechanism associates the PCC rule with the PDP context that is to carry the service data flow. When GPRS Tunnelling Protocol (GTP) is used between the BBERF and the PCEF then bearer binding is performed by the PCEF. Alternatively, when Proxy Mobile IP (PMIP) is used between the BBERF and the PCEF, instead of GTP, then bearer binding is performed by the BBERF.

The OCS provides authorization for the usage of network resources based on the provisioned data and the user activity information it receives from PCEF. This authorization must be granted by the OCS prior to the actual resource usage. When receiving a network resource usage request, the network assembles the relevant charging information and generates a charging event towards the OCS in real-time. The OCS then returns an appropriate resource usage authorization over the Gy interface. The resource usage authorization may be limited in its scope (e.g. volume of data or duration) therefore this authorization may have to be renewed from time to time as long as the user's resource usage persists. The OCS can support time, volume and event-based charging.

The AF is an element offering applications that require policy and/or charging control of the IP-CAN user plane behaviour. The AF communicates with the PCRF over the Rx interface to transfer dynamic session information (e.g. a description of the media to be delivered in the transport layer) required for PCRF decisions, as well as to receive IP-CAN specific information and notifications about IP-CAN bearer level events. One example of an AF is the P-CSCF of the IP Multimedia Core Network (IM CN) subsystem. In the case of a P-CSCF, the information communicated over the Rx interface is derived from the P-CSCF session information (e.g. SDP when SIP is used for signalling) and it mainly includes media components. A media component comprises a set of IP flows, each of which is described by a 5-tuple, the media type and required bandwidth.

The SPR contains all subscriber/subscription related information needed for subscription-based policies and IP-CAN bearer level PCC rules by the PCRF. The Sp interface allows the PCRF to request subscription information related to the IP-CAN transport level policies from the SPR based on a subscriber ID and other IP-CAN session attributes.

The 3GPP technical specifications define a mechanism to allow the PCRF to control and/or modify the bandwidth assigned to any service for which dynamic PCC rules are provided by the PCRF to the PCEF (i.e. a dynamic service). According to these specifications the authorized QoS provided by the PCRF to the PCEF can refer to a PCC rule, to an IP CAN bearer, to a QoS class identifier (QCI) or to an Access Point Name (APN), and provides appropriate values for the resources to be enforced. The authorized QoS per service data flow (SDF) is provisioned within the corresponding PCC rule by including the QoS-Information AVP within the Charging-Rule-Definition AVP in the Credit Control Answer (CCA) or Reauthorization Request (RAR) commands. If an authorized QoS is defined for a PCC rule, the PCEF shall limit the data rate of the service data flow corresponding to that PCC rule, such that it does not exceed the maximum authorized bandwidth, by discarding packets exceeding the limit. As such, the PCRF can control the bandwidth assigned to a dynamic service by introducing the Maximum Bit Rate (MBR) for the uplink (UL) and downlink (DL) as part of the QoS-Information AVP within the charging rule definition of that service.

The QoS-Information AVP takes the format:

QoS-Information::=<AVP Header: 1016>
[QoS-Class-Identifier]
[Max-Requested-Bandwidth-UL]
[Max-Requested-Bandwidth-DL]
[Guaranteed-Bitrate-UL]
[Guaranteed-Bitrate-DL]
[Bearer-Identifier]
[Allocation-Retention-Priority]
[APN-Aggregate-Max-Bitrate-UL]
[APN-Aggregate-Max-Bitrate-DL]
*[AVP]

The Max-Requested-Bandwidth-UL AVP defines the MBR allowed for the uplink direction. The Max-Requested-Bandwidth-DL AVP defines the MBR allowed for the downlink direction. The 3GPP technical specifications describe how a PCRF is able to set this MBR based on the service information obtained over the Rx interfaces from an AF (e.g. SDP information or other available application information), or based on internal PCRF information and/or the subscription information received from the SPR (see 3GPP TS 23.203 v 9.1.0).

The Charging-Rule-Definition AVP in the CCA or RAR commands also includes the Rating-Group AVP (see 3GPP TS 29.212 v 8.4.0). The Rating-Group AVP is defined in IETF RFC 4006 and contains the charging key used by both the online and offline charging systems to determine the cost of a service. As such, the PCRF can control the rating group assigned to a dynamic service by setting the Rating Group AVP within the charging rule definition of that service. As with the MBR, a PCRF is able to set this rating group based on the service information obtained over the Rx interfaces from an AF (e.g. SDP information or other available application information), or based on internal PCRF information and/or the subscription information received from the SPR.

Release 8 of the PCC technical specifications defines procedures that allow PCC rules to activated and deactivated at a specific time of day (see 3GPP TS 29.212 v 8.4.0). This functionality enables a PCRF to specify that PCC rules that are to be active during a given period, as defined by a rule activation time (Rule-Activation-Time AVP) and a rule deactivation time (Rule-Deactivation-Time AVP).

The Rule-Activation-Time and Rule-Deactivation-Time AVPs have been included in the Charging-Rule-Install AVP. The Charging-Rule-Install AVP takes the format:

Charging-Rule-Install::=<AVP Header: 1001>
*[Charging-Rule-Definition]
*[Charging-Rule-Name]
*[Charging-Rule-Base-Name]
[Bearer-Identifier]
[Rule-Activation-Time]
[Rule-Deactivation-Time]
*[AVP]

The Charging-Rule-Install AVP includes the Charging-Rule-Definition AVP that is used to define any dynamic PCC rules provided by the PCRF, as well as the Charging-Rule-Name AVP that activates a specific pre-defined PCC rule and the Charging-Rule-Base-Name AVP that may be used for activating a group of pre-defined PCC rules. As such, the PCRF can use the Rule-Activation-Time AVP and Rule-Deactivation-Time AVP to apply time of day functionality to both pre-defined and dynamic PCC rules. The rule activation time and rule deactivation time will apply to all PCC rules installed in a given instance of a Charging-Rule-Install AVP in which these AVPs are included. However, it is not mandatory to group those rules sharing the same rule activation time and rule deactivation time.

In addition, a PCRF is able to indicate to a PCEF a revalidation time (Revalidation-Time AVP), which indicates the time (e.g. Network Time Protocol (NTP) time) before which the PCEF will have to re-request the PCC rules. This value is provided with the REVALIDATION_TIMEOUT event trigger in a Credit Control Answer (CCA) or a Reauthorization Request (RAR) message. This prevents the sending of large amounts of control signalling (signalling storms) between the PCEF and the PCRF when the authorization state for a service (i.e. authorized/non-authorized) changes, as the PCEF initiates a request to update the authorization state before the end of the current period.

It has been recognised here that, whilst there are standardised mechanisms for allowing a PCRF to control the characteristics of a dynamic service (i.e. whose associated PCC rules are provisioned by the PCRF to the PCEF), such as the Maximum Bit Rate (MBR) and rating group of the service, there are no standardised mechanisms for allowing the PCRF to control the characteristics of pre-defined services (i.e. whose associated PCC rules are pre-defined in the PCEF). As such, it is left to individual network operators to specify the parameters of a pre-defined service in the PCEF. In particular, there are no mechanisms that enable a PCRF to control the parameters of a pre-defined service according to the time of day. The lack of such a mechanism prevents the implementation of certain types of functionality. For example, depending upon the user's subscription, the network operator may want to reduce the bandwidth provided for peer-to-peer (P2P) traffic during peak times, and/or apply flat rate charging for P2P services during off-peak times only.

### SUMMARY

It is an object of the present invention to overcome, or at least mitigate the problems identified above. This object is achieved by providing a method of allowing a PCRF to inform a PCEF of the characteristics which should be applied during a communication session.

According to a first aspect of the present invention there is provided a method of implementing policy and/or charging control for user communication sessions over an IP Connectivity Access Network. The method comprises:
at a Policy and Charging Enforcement Function, configuring a plurality of profiles, each profile defining one or more policy and/or charging control characteristics;
at a Policy and Charging Rules Function, configuring a plurality of profile selection rules to be used to determine which of the plurality of profiles should be applied to communication sessions;
at the Policy and Charging Enforcement Function, when establishing a communication session, sending a request for policy and/or charging control characteristics for the session to the Policy and Charging Rules Function;
at the Policy and Charging Rules Function, receiving the request, using the profile selection rules to select one or more profiles, and sending a response to the Policy and Charging Enforcement Function including an identifier for each of the one or more selected profiles; and
at the Policy and Charging Enforcement Function, receiving the response, retrieving the one or more policy and/or charging control characteristics from the one or more selected profiles identified in the response and enforcing the retrieved characteristics for the session.

Embodiments of the invention provide that network operators can set and/or modify the policy and/or charging control characteristics applied during a communication session, and in particular those to be applied to pre-defined services.

The request for policy and/or charging control characteristics sent by the Policy and Charging Enforcement Function may include an identifier for the participating user.

The profile selection rules may be configured to output the identifier for each of the one or more selected profiles as a result. The plurality of profile selection rules may also be configured to determine which of the plurality of profiles should be applied depending upon on one or more of:
subscription information of a user participating in the communication session; network resource information;
service information; and
network operator policy information.

The one or more policy and/or charging control characteristics defined by each of the plurality of profiles may relate to one or more services that can be provided to a user over the communication session. The policy and/or charging control characteristics defined by each of the plurality of profiles comprise one or more Quality of Service parameters and/or a rating group. The one or more Quality of Service parameters may comprise one or more of:
a Quality of Service Class Identifier;
a maximum bit rate allowed for the uplink direction;
a maximum bit rate allowed for the downlink direction;
a guaranteed bit rate allowed for the uplink direction; and
a guaranteed bit rate allowed for the downlink direction.

The profile selection rules may be further configured to determine one or more time periods during which one or more of the policy and/or charging control characteristics defined in the selected profiles should apply. If so, the method may further comprise, at the Policy and Charging Rules Function, using the profile selection rules to determine the one or more time periods during which one or more of the policy and/or charging control characteristics defined in the selected profiles should apply to the session, and including an indication of the one or more time periods together with an indication of the policy and/or charging control characteristics to which they apply in the response sent to the Policy and Charging Enforcement Function. For those characteristics for which a time period applies, the Policy and Charging Enforcement Function will only begin enforcing the characteristic at the start of the time period indicated for that characteristic in the response from the Policy and Charging Rules Function, and stops enforcing the characteristic at the end of the time period indicated for that characteristic in the response from the Policy and Charging Rules Function. The start of the time period may be indicated by an activation time and the end of the time period may be indicated by a deactivation time.

The method may further comprise, at the Policy and Charging Rules Function, determining a trigger time at which the Policy and Charging Enforcement Function should send a further request for policy and/or charging control characteristics for the session, and including an indication of this trigger time in the response sent to the Policy and Charging Enforcement Function. If so, the Policy and Charging Enforcement Function will send a further request for policy and/or charging control characteristics for the session at the trigger time indicated in the response.

The method may also further comprise, at the Policy and Charging Rules Function, subsequent to sending the response to the Policy and Charging Enforcement Function, determining that the one or more policy and/or charging control characteristics of the session require modification, using the profile selection rules to select one or more other profiles that should be applied to the session, and sending a request to the Policy and Charging Enforcement Function including an identifier for each of the one or more other profiles. Upon receiving the request, the Policy and Charging Enforcement Function retrieves the one or more policy and/or charging control characteristics from the one or more other profiles identified in the request and then enforces the modified characteristics for the session.

The method may yet further comprise, at the Policy and Charging Enforcement Function, subsequent to sending the request to the Policy and Charging Rules Function, determining that the one or more policy and/or charging control characteristics of the session require modification, and sending a further request for modified policy and/or charging control characteristics for the session to the Policy and Charging Rules Function. Upon receiving the request, the Policy and Charging Rules Function uses the profile selection rules to select one or more other profiles that define the modified policy and/or charging control characteristics that should be applied to the session, and sends a response to the Policy and Charging Enforcement Function including an identifier for each of the one or more other profiles.

According to a second aspect of the present invention there is provided a method of operating a Policy and Charging Enforcement Function to control a user communication session. The method comprises configuring a plurality of profiles, each profile defining one or more policy and/or charging control characteristics, then when establishing the communication session, sending a request for policy and/or charging control characteristics for the session to a Policy and Charging Rules Function, receiving a response from the Policy and Charging Rules Function including an identifier for one or more selected profiles, and retrieving the one or more policy and/or charging control characteristics from the one or more selected profiles identified in the response and enforcing the retrieved characteristics for the session.

According to a third aspect of the present invention there is provided a method of operating a Policy and Charging Rules Function to control user communication sessions. The method comprises configuring a plurality of profile selection rules to be used to determine which of a plurality of profiles define the policy and/or charging control characteristics that should be applied to communication sessions, receiving a request for policy and/or charging control characteristics for a communication session from a Policy and Charging Enforcement Function, using the profile selection rules to select one or more of the plurality of profiles that should apply to the communication session, and sending a response to the Policy and Charging Enforcement Function including an identifier for each of the one or more selected profiles.

According to a fourth aspect of the present invention there is provided an apparatus configured to operate as a Policy and Charging Enforcement Function. The apparatus comprises a memory for storing a plurality of profiles, each profile defining one or more policy and/or charging control characteristics, a first receiver for receiving a request to establish a communication session, a transmitter for sending a request for policy and/or charging control characteristics for the session to a Policy and Charging Rules Function, a second receiver for receiving a response from the Policy and Charging Rules Function including an identifier for one or more selected profiles, and a policy and/or charging control enforcement unit for retrieving the one or more policy and/or charging control characteristics from the one or more selected profiles identified in the response and for enforcing the retrieved characteristics for the session. The first and second receivers may be separate receivers or may be a single receiver suitable for both receiving the request to establish a communication session and receiving the response from the Policy and Charging Rules Function.

According to a fifth aspect of the present invention there is provided an apparatus configured to operate as a Policy and Charging Rules Function to control user communication sessions. The apparatus comprises a memory for storing a plurality of profile selection rules to be used to determine which of a plurality of profiles define the policy and/or charging control characteristics that should be applied to communication sessions, a receiver for receiving a request for policy and/or charging control characteristics for a communication session from a Policy and Charging Enforcement Function, a policy and/or charging control selection unit for using the profile selection rules to select one or more of the plurality of profiles that should apply to the communication session, and a transmitter for sending a response to the Policy and Charging Enforcement Function including an identifier for each of the one or more selected profiles.

### BRIEF DESCRIPTION OF THE DRAWINGS

FIG. 1 illustrates schematically an example of Policy and Charging Control architecture in accordance with 3GPP TS 23.203;

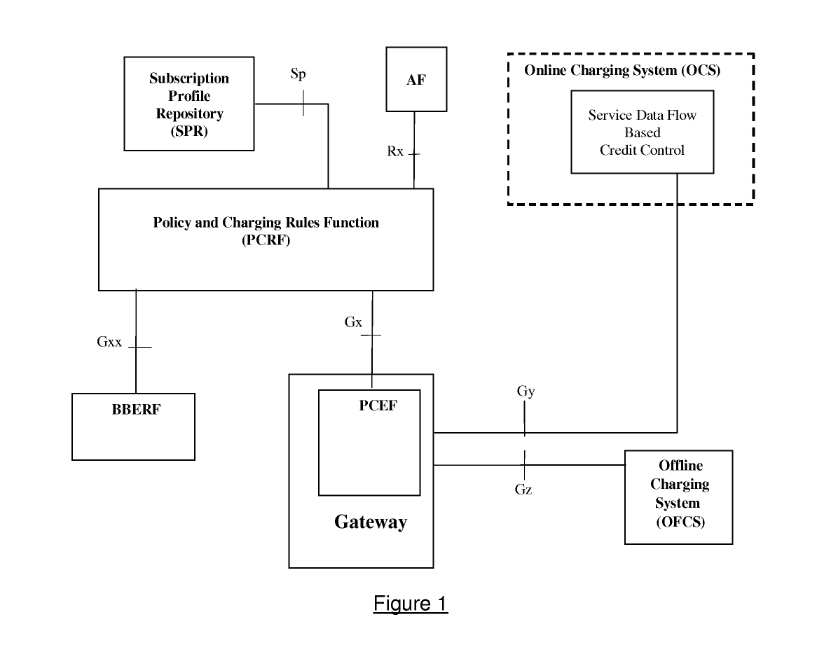

FIG. 2 illustrates an example signalling flow diagram of a Policy and Charging Rules Function providing service characteristic profiles to a Policy and Charging Enforcement Function according to an embodiment of the present invention;

FIG. 3 illustrates an example signalling flow diagram of a Policy and Charging Rules Function providing service characteristic profiles to a Policy and Charging Enforcement Function according to an embodiment of the present invention;

FIG. 4 illustrates schematically an example of a Policy and Charging Enforcement Function according to an embodiment of the present invention; and

FIG. 5 illustrates schematically an example of a Policy and Charging Rules Function according to an embodiment of the present invention.

### DETAILED DESCRIPTION

Whether the PCC rules for a service are pre-defined or dynamic depends on the type of service. Typically the PCC rules for a service are pre-defined because there is no Rx interface between the PCRF and the Application Function providing the service, or because the service cannot be identified by examining the IP 5 tuple (source IP address, destination IP address, source port number, destination port number, protocol ID of the protocol above IP). In contrast, it is possible to define dynamic PCC rules for a service whenever there is an Rx interface between the PCRF and the Application Function providing the service. For example, services provided by an IP Multimedia Subsystem (IMS), in which the IP addresses and ports are dynamic but can be determined by the PCRF by means of an Rx interface with a P-CSCF, are defined as dynamic services with dynamic PCC rules. However, for P2P services the IP addresses and ports used are not available to the PCRF, such that it is only the PCEF that can identify a P2P service using deep packet inspection (DPI) or heuristic analysis, and therefore PCC rules for this service will be pre-defined at the PCEF. Similarly, a PCEF can identify an internet service using the IP address of the server providing the web access, such that the PCC rules for such a service will also be pre-defined at the PCEF.

In order to overcome, or at least mitigate the problems identified above there will now be described a method of allowing a PCRF to inform a PCEF of the characteristics which should be applied to a particular service. According to this method, a number of service characteristic profiles are configured at the PCEF, each profile specifying one or more characteristics that are to be applied to one or more services. For example, each of the service characteristic profiles configured in the PCEF may contain a list of services, the UL and DL bandwidth applicable to each service, and/or the rating group applicable to each service. A service characteristic profile can specify any of the characteristics that should be applied to a service, such as the content filtering information, or routing information.

Each of these service characteristic profiles is identified by a profile identifier. A PCRF is configured with a number of profile selection rules that it can use to determine which service characteristic profile should be applied to a particular instance of a service, depending on the subscriber and/or the network conditions. Whilst the PCRF can select the profile(s) that should be applied by the PCEF, it does not necessarily need to store all of the policy and/or charging control characteristics defined by each profile. The PCRF can simply apply the profile selection rules to the session related information, the result of which may be an identifier for the one or more profiles that should apply to the session. Once the PCRF has selected the service characteristic profile(s) that should apply the PCRF can then inform the PCEF of the selected profile using the profile identifier. In addition, during the life of a session, the PCRF may determine that a different service characteristic profile should be applied, for example, if the user starts roaming or if the user has consumed all of their subscribed usage, and can modify the session accordingly by selecting a different service characteristic profile and informing the PCEF of the new profile's profile identifier.

This method can also be used to allow the PCRF to define and modify the characteristics of pre-defined services according to the time or day. This is achieved by permitting the PCRF to define an activation time and a deactivation time for each characteristic in the selected profile. Alternatively, the PCRF can define an activation time and a deactivation time for each of the profiles selected, such that this activation time and deactivation time applies to all of the characteristics within the selected profile. This time of day functionality can be achieved by configuring the PCRF with profile selection rules, the application of which result in the identification of one or more profiles that should apply for a session, together with the determination of a time period, defined by an activation and deactivation time, during which each characteristic in the selected profile, or each of the selected profiles, should apply. As an alternative, the profiles themselves could define both the characteristics to be applied, and the activation and deactivation times that should apply to those characteristics, the application of the profile selection rules simply identifying the appropriate profile(s).

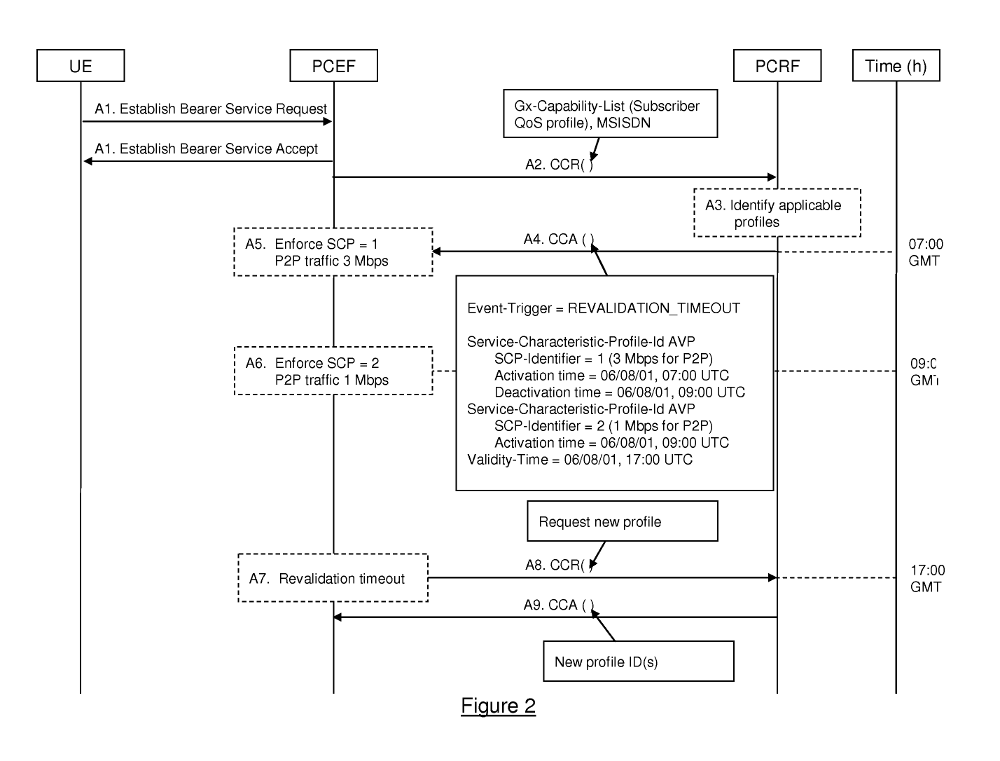

FIG. 2 illustrates an example signalling flow diagram of a PCRF providing service characteristic profiles to a PCEF in order to reduce the bandwidth provided to a subscriber for P2P traffic (e.g. a pre-defined service) during peak times. In this example, a subscriber is allowed up to 3 Mbps for P2P traffic during off-peak hours (e.g. between 17:00 and 9:00) but is limited to 1 Mbps in peak times (e.g. between 09:00 and 17:00). The steps performed are as follows:
A1. A bearer is established between the UE and the IP-CAN. For example, for a GPRS IP-CAN the bearer is a PDP context.
A2. Upon receipt of a request to establish a communication session, the PCEF sends a Credit Control Request (CCR) message to the PCRF in order to request policy and/or charging control information for the bearer. The CCR sent by the PCEF includes an indication that it supports the use of service characteristic profiles and identifies the subscriber. This can be achieved by including a new Gx-Capability-List AVP that provides indications of the capabilities supported by the PCEF. For example, the CCR can include a Gx-Capability-List AVP with the value ‘Subscriber QoS Profile’, and the subscriber's Mobile Subscriber ISDN (MSISDN).
A3. The PCRF uses the information in the CCR to obtain the user's subscription information, to evaluate the profile selection rules and select the service characteristic profiles that should apply to the session, and to determine the activation time and deactivation time for the profile or for each of the characteristics defined in the profile. In this example, the PCRF determines that Service Characteristic Profile (SCP) 1 should apply between 17:00 and 9:00, whereas SCP 2 should apply between 09:00 and 17:00.
A4. The PCRF then responds to the CCR with a Credit Control Answer (CCA) message including the Charging-Rule-Installation AVP that includes the profile identifier for SCP 1, together with the activation time and deactivation time that is to be applied to the profile. The Charging-Rule-Installation AVP also includes the profile identifier for SCP 2, together with the activation time and deactivation time that is to be applied to this profile. Of course, if either of SCP 1 or SCP 2 were to define more than one characteristic, then the Charging-Rule-Installation AVP could include an activation time and deactivation time for each of the characteristics defined in the profile. The PCRF also includes the Event-Trigger AVP with the REVALIDATION_TIMEOUT value within the CCA, indicating that a revalidation timeout should trigger the PCEF to send a re-request to the PCRF. The Revalidation-Time AVP indicates the time at which the re-request should be sent.
A5. The PCEF receives the CCA and uses the SCP identifiers to locate the Service Characteristic Profiles amongst those that have been pre-configured at the PCEF. The PCEF identifies that SCP 1 specifies a bandwidth limit of 3 Mbps for P2P services, and that SCP 2 specifies a bandwidth limit of 1 Mbps for P2P services. The PCEF begins applying SCP 1 to the bearer as it is currently within the activation time defined for that profile.
A6. When the PCEF reaches the deactivation time defined for SCP 1, the PCEF stops applying SCP 1. This time coincides with the activation time of SCP 2 such that the PCEF simultaneously begins applying SCP 2 to the bearer.
A7. When the PCEF reaches the revalidation time it sends a CCR message to the PCRF to request new profile information, and specifies within the Event-Trigger AVP that the REVALIDATION_TIMEOUT caused the modification.
A8. Upon receiving the CCR the PCRF re-evaluates the profile selection rules and responds to the CCR with a CCA message including the Charging-Rule-Installation AVP that now includes the profile identifier(s) those Service Characteristic Profiles that are now applicable, and time of day information for those profiles or for each of the characteristics defined in the profiles.

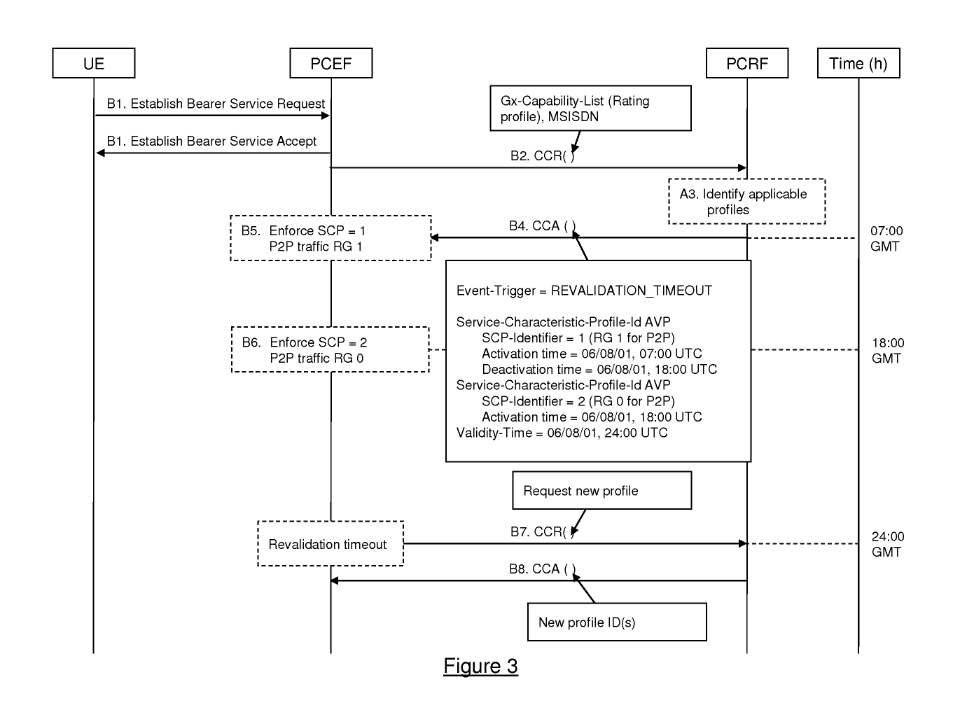

FIG. 3 illustrates an example signalling flow diagram of a PCRF providing service characteristic profiles to a PCEF in order to control charging for a P2P service (e.g. a pre-defined service). In this example, a flat rate charge is applied for P2P service used by the subscriber during off-peak hours, between 18:00 and 24:00. During the rest of the day volume-based charging is applied. The steps performed are as follows:
B1. A bearer is established between the UE and the IP-CAN. For example, for a GPRS IP-CAN the bearer is a PDP context.
B2. The PCEF sends a Credit Control Request (CCR) message to the PCRF in order to request policy and/or charging control information for the bearer. The CCR sent by the PCEF includes an indication that it supports the use of service characteristic profiles and identifies the subscriber. This can be achieved by including a new Gx-Capability-List AVP that provides indications of the capabilities supported by the PCEF. For example, the CCR can include a Gx-Capability-List AVP with the value ‘Rating Profile’, and the subscriber's Mobile Subscriber ISDN (MSISDN).
B3. The PCRF uses the information in the CCR to obtain the user's subscription information, evaluate the profile selection rules and select the service characteristic profiles that should apply to the session, and to determine the activation time and deactivation time for the profile or for each of the characteristics defined in the profile. In this example, the PCRF determines that the SCP 1 should apply to the session between 07:00 and 18:00, whereas SCP 2 is to apply between 18:00 and 24:00.
B4. The PCRF then responds to the CCR with a Credit Control Answer (CCA) message including the Charging-Rule-Installation AVP that includes the profile identifier for SCP 1, together with the activation time and deactivation time that is to be applied to the profile. The Charging-Rule-Installation AVP also includes the profile identifier for SCP 2, together with the activation time and deactivation time that is to be applied to this profile. Of course, if either of SCP 1 or SCP 2 were to define more than one characteristic, then the Charging-Rule-Installation AVP could include an activation time and deactivation time for each of the characteristics defined in the profile. The PCRF also includes the Event-Trigger AVP with the REVALIDATION_TIMEOUT value within the CCA, indicating that a revalidation timeout should trigger the PCEF to send a re-request to the PCRF. The Revalidation-Time AVP indicates the time at which the re-request should be sent.
B5. The PCEF receives the CCA and uses the SCP identifiers to locate the Service Characteristic Profiles amongst those that have been pre-configured at the PCEF. The PCEF identifies that that SCP 1 specifies Rating Group 1 for P2P services, and that SCP 2 specifies Rating Group 0 for P2P services. The PCEF begins applying SCP 1 to the bearer as it is currently within the activation time defined for that profile.
B6. When the PCEF reaches the deactivation time defined for SCP 1, the PCEF stops applying SCP 1. This time coincides with the activation time of SCP 2 such that the PCEF simultaneously begins applying SCP 2 to the bearer.
B7. When the PCEF reaches the revalidation time it sends a CCR message to the PCRF to request new profile information, and specifies within the Event-Trigger AVP that the REVALIDATION_TIMEOUT caused the modification.
B8. Upon receiving the CCR the PCRF re-evaluates the charging control policies and responds to the CCR with a CCA message including the Charging-Rule-Installation AVP that now includes the profile identifier(s) for those Service Characteristic Profiles that are now applicable, and time of day information for those profiles or for each of the characteristics defined in the profiles.

In order to implement these methods the Gx interface between the PCEF and the PCRF will require extension. The Gx interface could be extended to include the Gx-Capability-List AVP, to provide indications of the capabilities supported by the PCEF and/or the PCRF. The Gx interface could also be extended to include the service criteria profile information, such as the Service-Characteristic-Profile-Id AVP, which could include a Service-Characteristic-Profile-Identifier AVP for identifying the profile that should be applied by the PCEF. Theses AVPs could also include an Activation Time AVP and a Deactivation Time AVP for providing Time of Day functionality for these profiles. Multiple instances of the Service-Characteristic-Profile-Id could occur in CCA and RAR messages.

A Service-Characteristic-Profile-Id AVP could take the form:
Service-Characteristic-Profile-id::=<AVP Header: xxxx>
[Service-Characteristic-Profile-Identifier]
[Activation Time]
[Deactivation Time]
*[AVP]

As an alternative, the Gx interface could be extended to include AVPs for service criteria profiles relating to individual characteristics. For example, a service criteria profile defining the QoS characteristics for one or more services could take the form:

QoS-Profile-id::=<AVP Header: xxxx>
[QoS-Profile-Identifier]
[Activation Time]
[Deactivation Time]
*[AVP]

These methods could also make use of the Rule-Activation-Time AVP and Rule-Deactivation-Time AVP, as opposed to defining new Activation Time and Deactivation Time AVPs, to provide Time of Day functionality, and the Revalidation-Time AVP to indicate the time at which the PCEF should request new profile information from the PCRF.

By way of example, a CCA message containing the new or modified information elements (in bold) may take the format:

<CC-Answer>::=<Diameter Header: 272, PXY>
<Session-Id>
{Auth-Application-Id}
{Origin-Host}
{Origin-Realm}
[Result-Code]
[Experimental-Result]
{CC-Request-Type}
{CC-Request-Number}
[Bearer-Control-Mode]
*[Event-Trigger]
[Origin-State-Id]
*[Charging-Rule-Remove]
*[Charging-Rule-Install]
[Charging-Information]
[Online]
[Offline]
*[QoS-Information]
[Revalidation-Time]
[Error-Message]
[Error-Reporting-Host]
*[Failed-AVP]
*[Proxy-Info]
*[Route-Record]
*[Service-Characteristic-Profile-id]
*[AVP]

A RAR message containing the new or modified information elements (in bold) may take the format:
<RA-Request>::=<Diameter Header: 258, REQ, PXY>
<Session-Id>
{Auth-Application-Id}
{Origin-Host}
{Origin-Realm}
{Destination-Realm}
{Destination-Host}
{Re-Auth-Request-Type}
[Session-Release-Cause]
[Origin-State-Id]
*[Event-Trigger]
*[Charging-Rule-Remove]
*[Charging-Rule-Install]
*[QoS-Information]
[Revalidation-Time]
*[Proxy-Info]
*[Route-Record]
*[Service-Characteristic-Profile-id]
*[AVP]

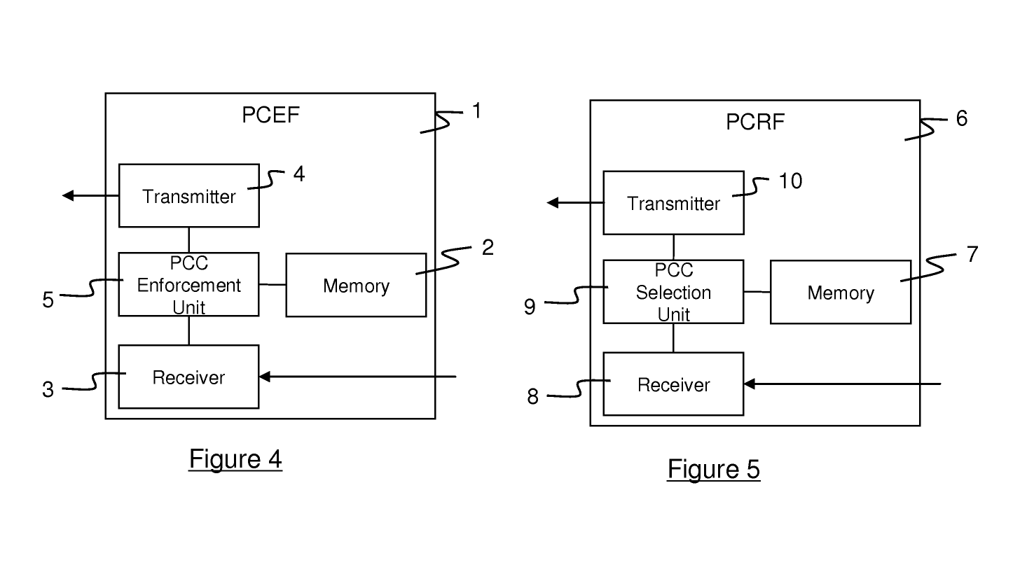

FIG. 4 illustrates schematically an example of a PCEF 1 suitable for implementing the method described above. The PCEF 1 can be implemented as a combination of computer hardware and software. The PCEF 1 comprises a memory 2, a receiver 3, a transmitter 4 and a policy and/or charging control enforcement unit 5. The service characteristic profiles that may be used by the PCEF 1 are configured at the PCEF 1 and stored in the memory 2. This can be done when the PCEF 1 is first initialised and, in addition, the PCEF 1 can be updated with new profile information at any time. A request to establish a communication session is then received by the receiver 3.

The PCEF 1 then determines that PCC information is required from a PCRF and sends a request for PCC information to the appropriate PCRF using the transmitter 4. The request sent to the PCRF may take the form of a CCR message and may include an indication that the PCEF 1 supports the use of service characteristic profiles together with an identifier for the subscriber. The request may also include any of the information defined in clause 7.2 of 3GPP TS23.203. A response from the PCRF is received by the receiver 3. The response may take the form of a CCA message. If the response includes one or more identifiers of respective service characteristic profiles then the policy and/or charging control enforcement unit 5 uses these identifiers to retrieve the policy and/or charging control characteristics from the associated service characteristic profiles stored within the memory 2, and enforces these characteristics for the session. In addition, the response may also indicate an activation time and deactivation time for each characteristic defined in each of the identified service characteristic profiles. The policy and/or charging control enforcement unit 5 will then only enforce the characteristics during the period defined by these times. Alternatively, the response may indicate an activation time and deactivation time that is to apply to each of the identified service characteristic profiles. In this case, the policy and/or charging control enforcement unit 5 will only enforce the characteristics defined in the associated profile during the period defined by these times.

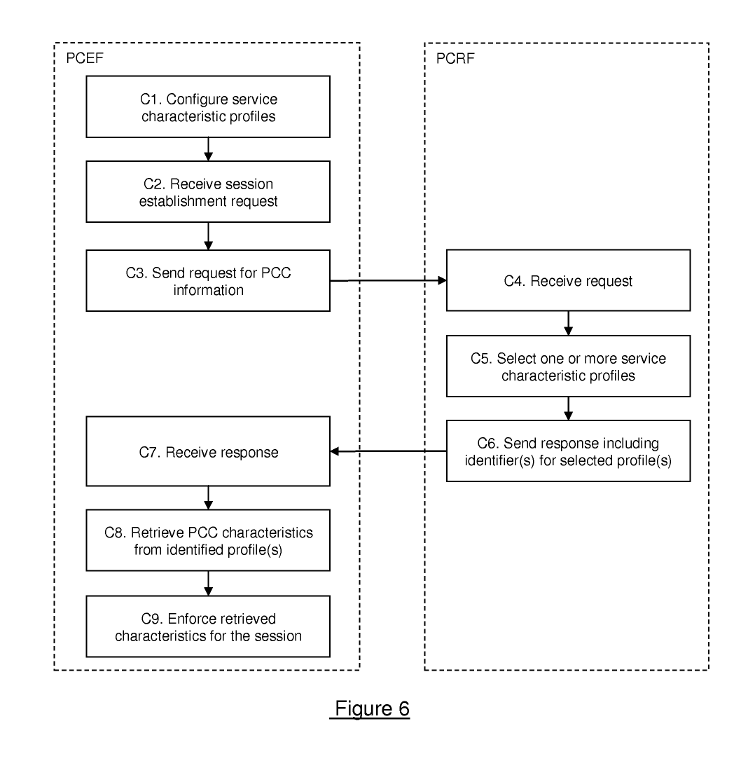

FIG. 5 illustrates schematically an example of a PCRF 6 suitable for implementing the method described above. The PCRF 6 can be implemented as a combination of computer hardware and software. The PCRF 6 comprises a memory 7, a receiver 8, a policy and/or charging control selection unit 9 and a transmitter 10. The PCRF 6 is configured with a number of profile selection rules that are stored in the memory 7, the application of these rules results in the identification of one or more profiles that should apply for a session. In addition, the application of the profile selection rules may also determine a time period during which each of the selected profiles, or each of the characteristics defined in the selected profiles, should apply. These time periods can be defined by an activation and deactivation time. A request from a PCEF for PCC information is then received by the receiver 8. As noted above, the request may take the form of a CCR message and may include an indication that the PCEF supports the use of service characteristic profiles together with an identifier for the subscriber. The policy and/or charging control selection unit 9 uses the information in the request to obtain the user's subscription information, and to evaluate the profile selection rules in order to select one or more service characteristic profiles that define the policy and/or charging control characteristics that should apply to the session. A response is then sent to the PCRF using the transmitter 10, including the identifiers for the one or more selected service characteristic profiles. The response may take the form of a CCA message. In addition, the policy and/or charging control selection unit 9 may also determine that one or more of the characteristics defined in the service characteristic profiles should only apply to the session during a specific time period. The response sent to the PCEF will then also include an activation time and deactivation time associated with these characteristics in the associated service characteristic profile. Alternatively, the policy and/or charging control selection unit 9 may determine that one or more of the service characteristic profiles, and therefore all of the characteristics defined in such a profile, should only apply to the session during a specific time period. In this case, the response sent to the PCEF will include an activation time and deactivation time associated with these service characteristic profiles.

FIG. 6 is a flow diagram illustrating steps of a generic process for implementing policy and/or charging control for a communication session in accordance with the embodiments described above. At step C1, the PCEF is configured with a number of service characteristic profiles, each profile defining one or more policy and/or charging control characteristics. At step C2, the PCEF receives a request to establish a session. At step C3, the PCEF sends a request for policy and/or charging information relating to the session to the PCRF. At step C4, the PCRF receives the request from the PCEF. At step C5, the PCRF evaluates the profile selection rules and identifies one or more service characteristic profiles that define the policy and/or charging control characteristics that should apply to the session. At step C6, the PCRF sends a response including the identifier(s) of the selected profile(s). At step C7, the PCEF receives the response. At step C8, the PCEF retrieves the policy and/or charging control characteristics for the profile(s) identified in the response. At step C9, the PCEF enforces the retrieved characteristics for the session.

The methods described above provide that network operators can set the characteristics of a pre-defined service (i.e. whose associated PCC rules are pre-defined in the PCEF and not provisioned by the PCRF), such as the Maximum Bit Rate (MBR) and rating group of the service. This also enables operators to modify the characteristics of a pre-defined service during an instance of that service. In particular, these methods enable network operators to control network resources available to subscribers for pre-defined services depending on the time of day. This is very useful as network resource consumption is not continuous, but fluctuates throughout the day. This also enables operators to create subscriptions that are intended to increase network resource usage at times when they are underutilised and decrease usage when consumption is at its highest. This also allows several service characteristic profiles to be identified by the PCRF to the PCEF, indicating for each one the activation time and deactivation time of the profiles. In doing so, the PCEF may enforce the changes in the service parameters throughout a day whilst avoiding the need for additional signalling between the PCEF and the PCRF.

It will be appreciated by the person of skill in the art that various modifications may be made to the above-described embodiments without departing from the scope of the present invention.

1. A method of implementing policy and/or charging control for user communication sessions over an IP Connectivity Access Network, the method comprising:
at a Policy and Charging Enforcement Function, configuring a plurality of profiles, each profile defining one or more policy and/or charging control characteristics;
at a Policy and Charging Rules Function, configuring a plurality of profile selection rules to be used to determine which of the plurality of profiles should be applied to communication sessions;
at the Policy and Charging Enforcement Function, when establishing a communication session, sending a request for policy and/or charging control characteristics for the session to the Policy and Charging Rules Function;
at the Policy and Charging Rules Function, receiving the request, using the profile selection rules to select one or more profiles, and sending a response to the Policy and Charging Enforcement Function including an identifier for each of the one or more selected profiles; and
at the Policy and Charging Enforcement Function, receiving the response, retrieving the one or more policy and/or charging control characteristics from the one or more selected profiles identified in the response and enforcing the retrieved characteristics for the session.

2. A method as claimed in claim 1, wherein the plurality of profile selection rules are configured to determine which of the plurality of profiles should be applied depending upon on one or more of:
subscription information of a user participating in the communication session;
network resource information;
service information; and
network operator policy information.

3. A method as claimed in claim 2, wherein request for policy and/or charging control characteristics sent by the Policy and Charging Enforcement Function includes an identifier for the participating user.

4. A method as claimed in claim 1, wherein the profile selection rules are configured to output the identifier for each of the one or more selected profiles as a result.

5. A method as claimed in claim 1, wherein the one or more policy and/or charging control characteristics defined by each of the plurality of profiles relate to one or more services that can be provided to a user over the communication session.

6. A method as claimed in claim 1, wherein the policy and/or charging control characteristics defined by each of the plurality of profiles comprise one or more of:
one or more Quality of Service parameters; and
a rating group.

7. A method as claimed in claim 6, wherein the one or more Quality of Service parameters comprise one or more of:
a Quality of Service Class Identifier;
a maximum bit rate allowed for the uplink direction;
a maximum bit rate allowed for the downlink direction;
a guaranteed bit rate allowed for the uplink direction; and
a guaranteed bit rate allowed for the downlink direction.

8. A method as claimed in claim 1, wherein the profile selection rules are further configured to determine one or more time periods during which one or more of the policy and/or charging control characteristics defined in the selected profiles should apply.

9. A method as claimed in claim 8, the method further comprising:
at the Policy and Charging Rules Function, using the profile selection rules to determine the one or more time periods during which one or more of the policy and/or charging control characteristics defined in the selected profiles should apply to the session, and including an indication of the one or more time periods together with an indication of the policy and/or charging control characteristics to which they apply in the response sent to the Policy and Charging Enforcement Function.

10. A method as claimed in claim 9, wherein, for those characteristics for which a time period applies, the Policy and Charging Enforcement Function only begins enforcing the characteristic at the start of the time period indicated for that characteristic in the response from the Policy and Charging Rules Function.

11. A method as claimed in claim 8, wherein, for those characteristics for which a time period applies, the Policy and Charging Enforcement Function stops enforcing the characteristic at the end of the time period indicated for that characteristic in the response from the Policy and Charging Rules Function.

12. A method as claimed in claim 8, wherein the start of the time period is indicated by an activation time and the end of the time period is indicated by a deactivation time.

13. A method as claimed in claim 1, the method further comprising:
at the Policy and Charging Rules Function, determining a trigger time at which the Policy and Charging Enforcement Function should send a further request for policy and/or charging control characteristics for the session, and including an indication of this trigger time in the response sent to the Policy and Charging Enforcement Function.

14. A method as claimed in claim 13, wherein the Policy and Charging Enforcement Function sends a further request for policy and/or charging control characteristics for the session at the trigger time indicated in the response.

15. A method as claimed in claim 1, the method further comprising:
at the Policy and Charging Rules Function, subsequent to sending the response to the Policy and Charging Enforcement Function, determining that the one or more policy and/or charging control characteristics of the session require modification, using the profile selection rules to select one or more other profiles that should be applied to the session, and sending a request to the Policy and Charging Enforcement Function including an identifier for each of the one or more other profiles; and
at the Policy and Charging Enforcement Function, receiving the request, retrieving the one or more policy and/or charging control characteristics from the one or more other profiles identified in the request and enforcing the modified characteristics for the session.

16. A method as claimed in claim 1, the method further comprising:
at the Policy and Charging Enforcement Function, subsequent to sending the request to the Policy and Charging Rules Function, determining that the one or more policy and/or charging control characteristics of the session require modification, and sending a further request for modified policy and/or charging control characteristics for the session to the Policy and Charging Rules Function; and
at the Policy and Charging Rules Function, receiving the further request, using the profile selection rules to select one or more other profiles that define the modified policy and/or charging control characteristics that should be applied to the session, and sending a response to the Policy and Charging Enforcement Function including an identifier for each of the one or more other profiles.

17. A method of operating a Policy and Charging Enforcement Function to control a user communication session, the method comprising
configuring a plurality of profiles, each profile defining one or more policy and/or charging control characteristics;
when establishing the communication session, sending a request for policy and/or charging control characteristics for the session to a Policy and Charging Rules Function;
receiving a response from the Policy and Charging Rules Function including an identifier for one or more selected profiles; and
retrieving the one or more policy and/or charging control characteristics from the one or more selected profiles identified in the response and enforcing the retrieved characteristics for the session.

18. A method of operating a Policy and Charging Rules Function to control user communication sessions, the method comprising:
configuring a plurality of profile selection rules to be used to determine which of a plurality of profiles define the policy and/or charging control characteristics that should be applied to communication sessions;
receiving a request for policy and/or charging control characteristics for a communication session from a Policy and Charging Enforcement Function;
using the profile selection rules to select one or more of the plurality of profiles that should apply to the communication session; and
sending a response to the Policy and Charging Enforcement Function including an identifier for each of the one or more selected profiles.

19. An apparatus configured to operate as a Policy and Charging Enforcement Function, the apparatus comprising
a memory for storing a plurality of profiles, each profile defining one or more policy and/or charging control characteristics;
a first receiver for receiving a request to establish a communication session;
a transmitter for sending a request for policy and/or charging control characteristics for the session to a Policy and Charging Rules Function;
a second receiver for receiving a response from the Policy and Charging Rules Function including an identifier for one or more selected profiles; and
a policy and/or charging control enforcement unit for retrieving the one or more policy and/or charging control characteristics from the one or more selected profiles identified in the response and for enforcing the retrieved characteristics for the session.

20. An apparatus configured to operate as a Policy and Charging Rules Function to control user communication sessions, the apparatus comprising:
a memory for storing a plurality of profile selection rules to be used to determine which of a plurality of profiles define the policy and/or charging control characteristics that should be applied to communication sessions;
a receiver for receiving a request for policy and/or charging control characteristics for a communication session from a Policy and Charging Enforcement Function;
a policy and/or charging control selection unit for using the profile selection rules to select one or more of the plurality of profiles that should apply to the communication session; and
a transmitter for sending a response to the Policy and Charging Enforcement Function including an identifier for each of the one or more selected profiles.
